(19) United States
(12) Patent Application Publication
(10) Pub. No.: US 2006/0085827 A1
(43) Pub. Date: Apr. 20, 2006

(54) Entertainment content preprocessing

(76) Inventor: Toshiro Ozawa, San Diego, CA (US)

Correspondence Address: MILLER PATENT SERVICES, 2500 DOCKERY LANE, RALEIGH, NC, 27606, US

(21) Appl. No.: 10/967,564

(22) Filed: Oct. 18, 2004

(51) Int. Cl. H04N 7/173; H04N 7/16

(52) U.S. Cl. 725/95; 725/135

(57) ABSTRACT

A method of preprocessing video entertainment content consistent with certain embodiments involves encoding the video entertainment content using a digital video encoding process to produce encoded digital video content; determining an amount of bandwidth consumed by the encoded digital video content; determining that an amount of bandwidth available in a transport stream is adequate to transport the encoded digital video content plus a segment of supplemental data; assigning a first packet identifier to packets containing the digital video content; packetizing the segment of supplemental data; assigning a second packet identifier to packets containing the supplemental data; and combining the supplemental data with the digital video content to produce a preprocessed digital signal. This abstract is not to be considered limiting, since other embodiments may deviate from the features described in this abstract.

### BACKGROUND

The bit rate of digitally encoded video signals, such as those encoded with MPEG-2 (Moving Pictures Expert Group), varies dynamically. When not enough data is generated from the encoder, null packets are added to create a constant bit rate output. Such null packets occupy approximately 5-8% of the transport stream, depending on the entertainment content being encoded.

These null packets are simply fillers that provide no meaningful data and can be viewed as a waste of bandwidth. It is possible to replace these null packets with more meaningful data without affecting the picture quality of the entertainment content being encoded by the video encoder.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 illustrates the varying bandwidth utilized in a transport stream.

FIG. 2 depicts a flow chart of a pre-processing method consistent with certain embodiments of the present invention.

FIG. 3 is a block diagram of an exemplary television set-top box used in a manner consistent with certain embodiments of the present invention.

FIG. 4 is a flow chart depicting operation of the exemplary television set-top box in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, in an executable application, an applet, a servlet, a source code, an object code, a shared library/dynamic load library and/or other sequence of instructions designed for execution on a computer system.

The term “video” may be used herein to embrace not only true visual information, but also in the conversational sense (e.g., “video tape recorder”) to embrace not only video signals but also associated audio and data. The exemplary embodiments disclosed herein are decoded by a television Set-Top Box (STB), but it is contemplated that such technology will soon be incorporated within television receivers of all types whether housed in a separate enclosure alone or in conjunction with recording and/or playback equipment or within a television set itself.

The present embodiments also describe a single Packet Identifier (PID) as being associated with a particular segment of video content, however those skilled in the art will appreciate that several such PIDs are commonly used in association with a particular television program. The use of a single PID is intended to simplify the explanation without intent to limit the disclosure.

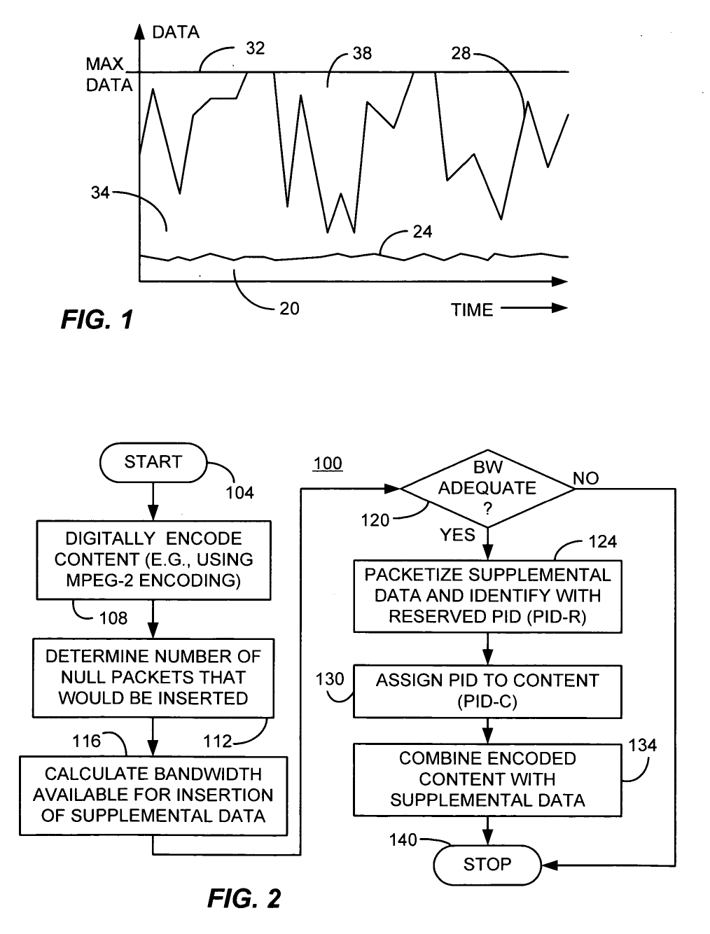

Referring now to FIG. 1, a graph of data versus time is shown for a video transport stream. Such transport stream carries audio and data content 20 which is a relatively small portion of the transport stream and is relatively constant bounded by line 24 on the graph of FIG. 1. Line 28 of the graph of FIG. 1 depicts a boundary for the audio plus video content in the transport stream. As can be seen, the video content does not always consume the entire maximum data capacity of the channel which is shown bounded by line 32. The area below curve 28 represents video data 34. The area between line 32 and curve 28 shown as 38 represents areas that are filled with null packets.

As previously noted, in an average video transport stream, null packets occupy approximately 5-8% of the stream, depending upon the entertainment content. This 5-8% represents a substantial amount of wasted data throughput. If it is possible to own the entire transport stream for a period of time (for example, in the case of a television commercial or a movie produced by a particular vendor), this extra space can be used for other purposes such as software downloads or distribution of other entertainment content, that is not time critical. The size of the available space varies, but can be predetermined by test encoding the entertainment content using the same encoding mechanism that will be used in the final video entertainment content.

By way of example, for a 30-second television commercial, approximately 3 megabytes of data may be available for this purpose. For a 2-hour movie, hundreds of megabytes of data might be available. In one exemplary embodiment, the extra data bandwidth can be utilized to download a software upgrade to a television set-top box or to a television device or home network device connected to a cable television network. In order to accomplish this, the entertainment content can be supplied for distribution in a manner that is already pre-encoded into the final digital format in which it is to be broadcast. Consequently, rather than providing conventional analog material to a cable system headend for encoding, the entertainment content can be pre-encoded with supplementary data encoded along with it.

One process for pre-processing entertainment content is depicted in flow chart 100 of FIG. 2 starting at 104. This process can be carried out using a general purpose computer operating on the entertainment content using a computer program. At 108, the entertainment content is digitally encoded using the same encoding technique that would be utilized by the broadcaster or cable system headend for distribution of the entertainment content. For example, but not by way of any limitation, MPEG-2 encoding could be utilized. Once the main entertainment content is encoded at 108, a determination can be made at 112 as to the number of null packets that would normally be inserted into the transport stream to fill the transport stream to the maximum data rate. From this determination at 112, one can calculate at 116 the bandwidth available for insertion of supplemental data such as a software update and determine at 120 whether or not the bandwidth is adequate for the supplemental data that is to be inserted. If the bandwidth is not adequate, other actions may need to be taken, such as for example breaking the supplemental content up into several parts or finding a new source of main entertainment content in which to embed the supplemental data.

However, if the bandwidth is determined to be adequate at 120, then the supplemental data can be encoded at 124 and identified in a transport stream using a reserved Packet Identifier (PID) which is designated in the drawings for convenience as PID-R. In a similar manner, at 130, the main entertainment content is assigned a PID which identifies the main entertainment content (in the drawings PID-C). The encoded entertainment content and the encoded supplemental data along with System Information (SI) such as Program Management Table (PMT) and Program Allocation Table (PAT) tables are then combined at 134, and null packets are inserted as required to finish filling the transport stream. The process then ends at 140 with a combined set of encoded entertainment content and supplemental data which can be provided to the broadcaster or cable system for distribution.

As will be appreciated by those skilled in the art, the number of null packets that will be inserted into a transport stream is only predictable if the content of the entire transport stream is predictable. This is generally the case only if the entire transport stream is under the control of a single entity. One example of such a situation is the case of High Definition (HD) television transport streams. In the case of HD television broadcasting, a single transport stream is allotted to a single HD television program which occupies a bandwidth of 19.2 Mbps.

In standard definition, a transport stream usually carries 8-10 television services that are multiplexed together. In some instances, a fixed bit rate is assigned to each service, in which case each service can be considered a transport stream for purposes of this invention. In other cases, bit rates are assigned dynamically using statistical multiplexing. In this case, the entire transport stream should be controlled by the entity doing the preprocessing, or the preprocessing should be coordinated with the controlling entity in some manner to assure that only an appropriate stream bandwidth is consumed by the preprocessing. Many variations will occur to those skilled in the art upon consideration of the present teachings.

Thus, a method of preprocessing video entertainment content consistent with certain embodiments involves encoding the video entertainment content using a digital video encoding process to produce encoded digital video content; determining an amount of bandwidth consumed by the encoded digital video content; determining that an amount of bandwidth available in a transport stream is adequate to transport the encoded digital video content plus a segment of supplemental data; assigning a first packet identifier to packets containing the digital video content; packetizing the segment of supplemental data; assigning a second packet identifier to packets containing the supplemental data; and combining the supplemental data with the digital video content to produce a preprocessed digital signal.

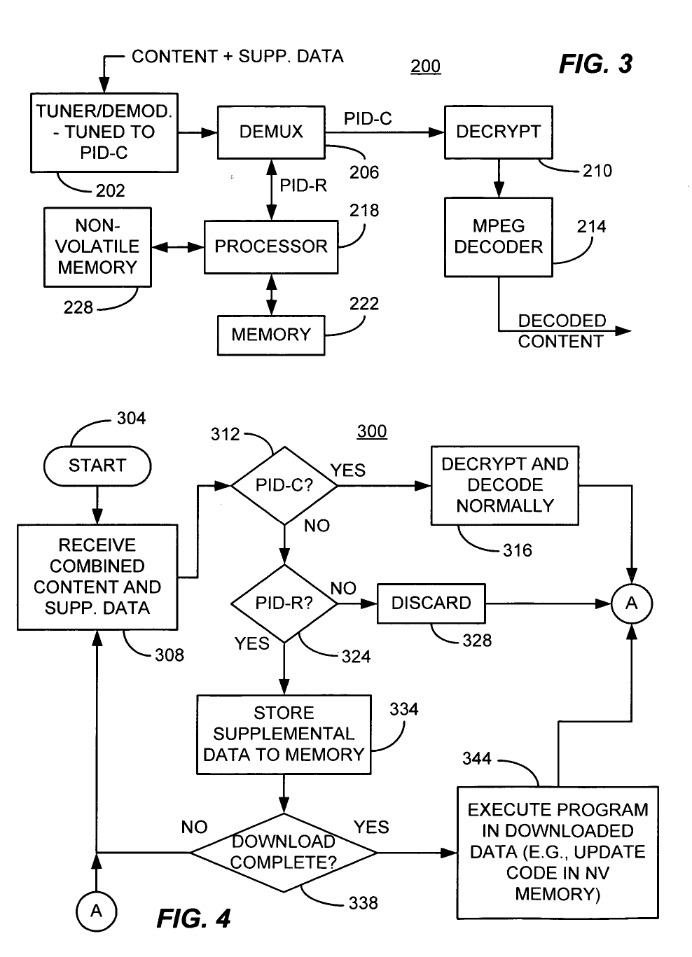

In accordance with the above process, entertainment content can be pre-processed to produce a package of data containing both the original entertainment content and supplemental data that can be utilized for any number of desired purposes. In one exemplary embodiment, consider the upgrading of software in a digital television set-top box used in cable network. A block diagram of such a set-top box is shown in FIG. 3 with only the relevant circuit blocks shown for clarity. The entertainment content plus the supplement data are received at a tuner demodulator that is tuned to a transport stream carrying PID-C at 202. The transport stream is then demultiplexed at demultiplexer 206, and packets identified by PID-C are forwarded to decrypter 210 for decryption and MPEG decoder 214 for decoding to produce the decoded entertainment content as an output.

At the demultiplexer 206, packets that are designated as having PID-R (a reserved PID used for updates of the software or firmware of set-top box 200) are passed to processor 218 which accumulates the data packets or the payload thereof in memory 222. If a firmware update is to take place, once the entire update is received and verified for error-free receipt, the supplemental data, which may be an executable computer program, are then executed to load new programming into nonvolatile memory 228.

Thus, a television receiver device consistent with certain embodiments has a tuner that receives a transport stream containing a preprocessed digital video signal, wherein the preprocessed digital video signal comprises packetized encoded digital video content and packetized supplemental data. A first packet identifier is assigned to packets containing the digital video content, and a second packet identifier is assigned to packets containing the supplemental data, and the second packet identifier is reserved for packets containing the supplemental data. A demultiplexer demultiplexes the preprocessed digital video signal according to the packet identifier. A decoder decodes the packets having the first packet identifier to produce decoded video output. A storage device is provided. A processor stores the data in the packets having the second packet identifier in the storage device for use as supplemental data used for upgrading software or firmware associated with the receiver device.

This process may be used to upgrade either the receiver device (e.g., a television or a television set-top box) or a connected device.

The process described above is depicted in greater detail in the flow chart 300 of FIG. 4 starting at 304. At 308, when the combined entertainment content and supplemental data are received, the demultiplexer 206 makes a determination as to whether or not packets are identified by PID-C at 312. Those packets identified by PID-C are decrypted and decoded normally at 316 and the process returns to 308.

If at 312, the packet is not identified as having PID-C, it is inspected to determine if the packet has PID-R at 324. If not, the packet is discarded at 328 and control returns to 308. However, if the packet is identified by PID-R at 324, the supplemental data are stored to memory at 334 until it is determined that the download is complete at 338. If the download is not complete, control returns to 308 until more data are received identified by PID-R. Once the download is complete at 338, the program can be executed at the desired time or according to a desired cue or set of circumstances by processor 218 at 344, for example in order to affect an update of the nonvolatile memory 228. Control then returns to 308.

Thus, a method for processing a preprocessed video signal at a receiver device involves receiving a transport stream containing a preprocessed digital video signal, wherein the preprocessed digital video signal comprises packetized encoded digital video content and packetized supplemental data; wherein a first packet identifier is assigned to packets containing the digital video content, and a second packet identifier is assigned to packets containing the supplemental data, and wherein the second packet identifier is reserved for packets containing the supplemental data; demultiplexing the preprocessed digital video signal according to the packet identifiers; decoding the packets having the first packet identifier to produce decoded video output; and storing data in the packets having the second packet identifier as supplemental data used for upgrading software or firmware associated with the receiver device.

This preprocessing may be particularly advantageous for software or firmware upgrades to hardware for device manufacturers that are also content producers or that work with content producers. In this manner, the content producer can incorporate upgrades into content which may be likely to be received by a large population of target devices. Television set-top boxes are a good example, where broadcast of the content by way of a commercial advertisement over a particular cable system could be assured to be received by a large population of target set-top boxes.

While the present disclosure has been based upon an exemplary embodiment wherein a television set-top box receives supplemental data in order to upgrade software or firmware, this should not be considered limiting since any other type of data could similarly be packaged using the pre-processing technique described herein. Accordingly, the present invention should be construed to encompass any such pre-processing that falls within the spirit and scope of the appended claims. In a similar manner, although MPEG encoding has been described, any other suitable digital encoding format that similarly utilizes null packets could be used without limitation.

Those skilled in the art will recognize, upon consideration of the above teachings, that certain of the above exemplary embodiments are based upon use of a programmed processor such as 218. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain embodiments described herein, are or may be implemented using a programmed processor executing programming instructions that are broadly described above in flow chart form that can be stored on any suitable electronic or computer readable storage medium and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

Software and/or firmware embodiments may be implemented using a programmed processor executing programming instructions that in certain instances are broadly described above in flow chart form that can be stored on any suitable electronic or computer readable storage medium (such as, for example, disc storage, Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies) and/or can be transmitted over any suitable electronic communication medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A method of preprocessing video entertainment content, comprising:
encoding the video entertainment content using a digital video encoding process to produce encoded digital video content;
determining an amount of bandwidth consumed by the encoded digital video content;
determining that an amount of bandwidth available in a transport stream is adequate to transport the encoded digital video content plus a segment of supplemental data;
assigning a first packet identifier to packets containing the digital video content;
packetizing the segment of supplemental data;
assigning a second packet identifier to packets containing the supplemental data; and
combining the supplemental data with the digital video content to produce a preprocessed digital signal.

2. The preprocessing method according to claim 1, further comprising:
determining that the additional bandwidth is available in the transport stream beyond that occupied by the encoded digital video content plus the packetized supplemental data; and
filling the additional bandwidth with null packets.

3. The preprocessing method according to claim 1, wherein the supplemental data comprises data used to upgrade computer executable code.

4. The preprocessing method according to claim 1, wherein the supplemental data comprises a software or firmware upgrade for a computer program.

5. The preprocessing method according to claim 1, wherein the supplemental content comprises computer executable code used to upgrade the software or firmware for a television set-top box.

6. The preprocessing method according to claim 1, wherein the entertainment content comprises one of a television program, a movie, and a television commercial.

7. The preprocessing method according to claim 1, wherein the second packet identifier comprises a reserved packet identifier used exclusively for receipt of prescribed supplemental data.

8. A computer readable storage medium storing instructions which, when executed on a programmed processor, carry out a preprocessing method according to claim 1.

9. A transport stream produced according to the process of claim 1.

10. A method of preprocessing video entertainment content, comprising:
encoding the video entertainment content using a digital video encoding process to produce encoded digital video content;
wherein the entertainment content comprises one of a television program, a movie, and a television commercial
determining an amount of bandwidth consumed by the encoded digital video content;
determining that an amount of bandwidth available in a transport stream is adequate to transport the encoded digital video content plus a segment of supplemental data;
wherein the supplemental data comprises computer executable code used to upgrade the software or firmware for a television set-top box;
assigning a first packet identifier to packets containing the digital video content;
packetizing the segment of supplemental data;
assigning a second packet identifier to packets containing the supplemental data;
wherein the second packet identifier comprises a reserved packet identifier used exclusively for receipt of prescribed supplemental data;
combining the supplemental data with the digital video content to produce a preprocessed digital signal;
determining that the additional bandwidth is available in the transport stream beyond that occupied by the encoded digital video content plus the packetized supplemental data; and
filling the additional bandwidth with null packets.

11. A computer readable storage medium storing instructions which, when executed on a programmed processor, carry out a preprocessing method according to claim 10.

12. A transport stream produced according to the process of claim 10.

13. A method for processing a preprocessed video signal at a receiver device, comprising:
receiving a transport stream containing a preprocessed digital video signal, wherein the preprocessed digital video signal comprises packetized encoded digital video content and packetized supplemental data;
wherein a first packet identifier is assigned to packets containing the digital video content, and a second packet identifier is assigned to packets containing the supplemental data, and wherein the second packet identifier is reserved for packets containing the supplemental data;
demultiplexing the preprocessed digital video signal according to the packet identifiers;
decoding the packets having the first packet identifier to produce decoded video output; and
storing data in the packets having the second packet identifier as supplemental data used for upgrading software or firmware associated with the receiver device.

14. The method according to claim 13, further comprising discarding null packets.

15. The method according to claim 13, wherein the supplemental data comprises computer executable code used to upgrade a computer program.

16. The method according to claim 13, wherein the supplemental content comprises computer executable code used to upgrade the software or firmware for a television set-top box.

17. The method according to claim 13, wherein the entertainment content comprises one of a television program, a movie, and a television commercial.

18. The method according to claim 13, further comprising decrypting the packets having the first packet identifier.

19. The method according to claim 13, carried out in a television set-top box.

20. A computer readable storage medium storing instructions which, when executed on a programmed processor, carry out a preprocessing method according to claim 13.

21. A television receiver device, comprising:
a tuner that receives a transport stream containing a preprocessed digital video signal, wherein the preprocessed digital video signal comprises packetized encoded digital video content and packetized supplemental data;
wherein a first packet identifier is assigned to packets containing the digital video content, and a second packet identifier is assigned to packets containing the supplemental data, and wherein the second packet identifier is reserved for packets containing the supplemental data;
a demultiplexer that demultiplexes the preprocessed digital video signal according to the packet identifiers;
a decoder that decodes the packets having the first packet identifier to produce decoded video output;
a storage device; and
a processor that stores the data in the packets having the second packet identifier in the storage device for use as supplemental data used for upgrading software or firmware associated with the receiver device.

22. The device according to claim 21, wherein the demultiplexer discards null packets.

23. The device according to claim 21, wherein the supplemental data comprises computer executable code used to upgrade a computer program.

24. The device according to claim 23, wherein the processor executes the executable code to a non-volatile memory in order to upgrade an operational program of the receiver device.

25. The device according to claim 21, wherein the supplemental content comprises computer executable code used to upgrade the software or firmware for a television set-top box.

26. The device according to claim 21, wherein the entertainment content comprises one of a television program, a movie, and a television commercial.

27. The device according to claim 21, wherein the receiver device comprises a television set-top box.

28. The device according to claim 21, wherein the decoder comprises an MPEG compliant decoder.

29. A television set-top box, comprising:
a tuner that receives a transport stream containing a preprocessed digital video signal, wherein the preprocessed digital video signal comprises packetized encoded digital video content and packetized supplemental data;
wherein a first packet identifier is assigned to packets containing the digital video content, and a second packet identifier is assigned to packets containing the supplemental data, and wherein the second packet identifier is reserved for packets containing the supplemental data;
wherein the supplemental data comprises computer executable code used to upgrade a computer program;
a demultiplexer that demultiplexes the preprocessed digital video signal according to the packet identifiers and discards null packets;
an MPEG compliant decoder that decodes the packets having the first packet identifier to produce decoded video output;
a storage device;
a non-volatile memory; and
a processor that stores the data in the packets having the second packet identifier in the storage device for use as supplemental data used for upgrading software or firmware associated with the receiver device, and executes the executable code to the non-volatile memory in order to upgrade an operational program of the receiver device.
